(19) United States
(12) Patent Application Publication
(10) Pub. No.: US 2024/0388521 A1
(43) Pub. Date: Nov. 21, 2024

(54) METHOD AND SYSTEM FOR LARGE-SCALE TRAFFIC GENERATION BASED ON PROGRAMMABLE NETWORK TECHNOLOGY

(71) Applicants: ZHEJIANG UNIVERSITY, Hangzhou (CN); ZHEJIANG LAB, Hangzhou (CN)

(72) Inventors: Haifeng ZHOU, Hangzhou (CN); Di WANG, Hangzhou (CN); Xiang CHEN, Hangzhou (CN); Chunming WU, Hangzhou (CN); Wenhai WANG, Hangzhou (CN)

(21) Appl. No.: 18/664,368

(22) Filed: May 15, 2024

(30) Foreign Application Priority Data
May 15, 2023 (CN) 202310542543.5

(51) Int. Cl. H04L 43/55; H04L 9/40; H04L 69/326

(52) U.S. Cl. CPC H04L 43/55; H04L 63/1458; H04L 69/326

(57) ABSTRACT

A method and a system for large-scale traffic generation based on programmable network technology, which are used for the research on network operation and maintenance and defense of attacks such as DDOS. According to the method, the required large-scale traffic is generated as required through the coordination of servers and programmable switches. The method specifically comprises the steps of designing a series of primitives which are based on intentions and are irrelevant to underlying architecture details, and reducing the description difficulty of generating large-scale traffic intentions; completing required configurations on the switch and the server by the designed cooperation mechanism of the server and programmable switch according to intentions expressed by different types of primitives, and achieving large-scale traffic generation by coordinating and utilizing server and switch resources.

### CROSS-REFERENCE TO RELATED APPLICATIONS

The present application claims priority to Chinese Patent Application No. 202310542543.5, filed on May 15, 2023, the content of which is incorporated herein by reference in its entirety.

### TECHNICAL FIELD

The present disclosure relates to the technical field of computer networks, and in particular, to a method and a system for large-scale traffic generation based on programmable network technology.

### BACKGROUND

The generation of large-scale network traffic is of great significance for conducting research on network operation and maintenance and defense against network attacks (such as DDoS). There are two main methods for generating large-scale network traffic:

(1) Kernel-based tools are used to generate large-scale traffic. These tools rely on the system kernel space library when generating traffic, and make frequent calls to the system kernel, which brings huge performance overhead and limits the size of the large-scale traffic that can be generated, generally only up to several gigabytes per second, making it impossible to simulate the real large-scale traffic, for example, millions of megabits (Tbps) level DDOS attacks.

(2) Kernel-by-passing method is adopted to generate large-scale traffic. This method does not involve the kernel space, and generates and sends data packets in a user space. The traffic generated by this method can reach tens of thousands of megabytes per second, which has high scalability. However, the cost of this kind of equipment is high, for example the cost of generating large-scale traffic of Tbps level has exceeded 100 thousand dollars.

To sum up, the current generation method cannot achieve the generation of large-

scale traffic at a low cost. The P4 programmable switch proposed in recent years provides a new idea to generate large-scale traffic.

A P4 programmable switch brings the programmability of data plane, with the data packet processing Pipeline architecture thereof capable of processing data packets at a linear speed and supporting developers to customize network protocols and related processing flows.

This means that a single switch can rapidly expand data traffic to Tbps through recycling, multi-pipeline cooperation and other mechanisms in a short time. At the same time, a single 6.4Tbps P4 programmable switch costs less than $10,000 with low expansion costs. However, the programmable switch can only provide limited resources, with small custom data packet buffer sizes, making it difficult to support tasks such as large-scale data packet header modification and payload content filling. As a result, fulfilling demands for generating large-scale traffic becomes challenging to achieve with programmable switches.

Therefore, the resources of programmable switches are limited, and the technical problems of increasing server groups or switches to increase the scale of network traffic need to be solved urgently.

### SUMMARY

In view of the shortcomings of the prior art, the present disclosure aims to provide a method and a system for generating large-scale traffic based on programmable network technology, which are used for the research on network operation and maintenance and defense of attacks such as DDOS. According to the method, the required large-scale traffic is generated as required through the coordination of servers and programmable switches. The method specifically comprises the steps of designing a series of primitives which are based on intentions and are irrelevant to underlying architecture details, and reducing the description difficulty of generating large-scale traffic intentions; completing required configurations on the switch and the server by the designed cooperation mechanism of the server and programmable switch according to intentions expressed by different types of primitives, and achieving large-scale traffic generation by coordinating and utilizing server and switch resources.

The object of the present disclosure is achieved through the following technical solution:

A large-scale traffic generation method based on programmable network technology specifically includes the following steps:

(1) Generating task intention primitives. The task intention primitives include two types: traffic generation primitives and traffic control primitives, which are used to clearly express an intent of a large-scale traffic generation task.

(2) Classifying the task intention primitives, including: classifying the large-scale traffic generation task expressed by the task intention primitives into a hardware compatible primitive set and a hardware incompatible primitive set according to whether the task intention primitives are compatible with a resource limitation of a switch.

(3) Generating initial traffic generation, including: configuring a server group according to the task intention primitives in the hardware incompatible primitive set to generate data packets that meet task requirements, and then creating an initial traffic set.

(4) Interacting a server with the switch, including: when creating an initial traffic, sending the data packets in the initial traffic set and a traffic control configuration in the hardware compatible primitive set to the switch through a link connecting the server group and the switch for controlling a subsequent traffic by a pipeline processing program of the switch.

(5) Controlling a traffic, including: sending and controlling, by the programmable switch, the initial traffic set sent from the server group by using a pipeline processor according to traffic control requirements of hardware compatible primitives, so that the generated large-scale traffic meet a task configuration requirement.

Further, the traffic generation primitives in step (1) are configured to define an initial format of the data packet of the large-scale traffic, and specifically include the following primitives:

(2.1) Setting the header structure L_{header} of packets: Set_Packet_Structure(L_{header}).

(2.2) Selecting a set of header fields L_{field} in different data packets: Select_Field(L_{field})

(2.3) Setting the specific header fields L_{field} of the data packet as specified values Lᵥₐₗᵤₑ: Set_Field_Value(L_{field}, Lᵥₐₗᵤₑ)

(2.4) Setting aper-packet length to l: Set_Packet_Length(l)

(2.5) Setting k data flows with the largest traffic in the initial traffic set, namely top-k flows, with probability of occurrence between μₘᵢₙ and μₘₐₓ: Set_Prob(k, L_{field}, μₘᵢₙ, μₘₐₓ).

(2.6) Replaying a traffic trace F specified by a user as a large-scale traffic: Replay_Trace(F).

Further, the traffic control primitives in step (1) are used to express a task intention of controlling the initial traffic set, and specifically include the following primitives:

(3.1) Setting the switch port list Lₚₒᵣₜ to emit large-scale traffic: Set_Port (Lₚₒᵣₜ).

(3.2) Setting a rate γ for sending the large-scale traffic: Set_Rate(γ).

(3.3) Setting a total number of times Nₜₑₛₜ for sending the large-scale traffic: Set_Number(Nₜₑₛₜ).

(3.4) Setting a duration D (seconds) for sending the large-scale traffic each time: Set_Duration(D)

(3.5) Setting a time interval I (seconds) for sending the large-scale traffic consecutively for two times: Set_Interval(I).

Further, a process of the task primitive classification specifically includes: enumerating each primitive in a task T for generating the large-scale traffic. Because the task T needs to change header structures of the data packet or payloads, and these header structures or payloads are disabled on the switch due to the limitation of switch resources. Determining, for each primitive P∈T, whether P belongs to an attack traffic generation primitive; if so, P is incompatible with the switch resources, and is added to the hardware incompatible primitive set Ωₛₑᵣᵥₑᵣ; otherwise, P is classified into the hardware compatible primitive set.

Further, the initial traffic generation in step (3) includes the following steps:

(5.1) Generating the data packets, including: setting a header structure of the data packet according to the primitive Set_Packet_Structure (L_{header}), performing field initialization, establishing a dependency of header fields, and determining a total number of required initial data packets.

(5.2) Setting a set of header fields, including: setting the header fields of the data packets in two ways: a random value or the fixed value according to primitives Select_Field (L_{field}) and Set_Field_Value (L_{field}, Lᵥₐₗᵤₑ).

(5.3) Updating per-packet length, including: intercepting or expanding the payload part of the data packet until meeting the packet/specified by Set_Packet_Length (l).

(5.4) Setting probabilities of the data packet, including: setting the probability that top k flows appear in the initial traffic to be between μₘᵢₙ and μₘₐₓ according to Set_Prob(k, L_{field}, μₘᵢₙ, μₘₐₓ).

(5.5) Replaying user-specified data flows, including: providing a function of user-defined initial data flows, and replaying user-specified data packets according to Replay_Trace(F) to form a final attack traffic set P_{T}.

Further, the traffic control configuration extracted in step (4) includes an expected sending rate γ, the switch port list Lₚₒᵣₜ for sending the data packet, the total number of times N for sending the large-scale traffic, the duration D for sending the large-scale traffic each time, and the time interval/for sending the large-scale traffic consecutively for two times.

Further, the pipeline processor in step (5) receives the initial traffic set P_{T} and the traffic control requirements in the user-specified hardware compatible primitive set Ωₚᵢₚₑ, and uses basic data packet processing elements in a pipeline to control and send the large-scale traffic, which includes the following steps:

(7.1) Controlling the data message rate, including: controlling the large-scale traffic to be sent out at multiple specified ports Set_Port (Lₚₒᵣₜ) by applying a recycling and color marking mechanism or a multi-pipeline cooperation mechanism, and controlling a traffic rate to meet the requirement of an expected sending rate Set_Rate (γ).

(7.2) Controlling the data packet termination, including: counting the data packets and monitoring the duration, and terminating sending the data packets when exceeding the user-specified test number Set_Number (Nₜₑₛₜ).

(7.3) Controlling the duration of the data packets, including: recording a timestamp t_{old} indicating when its rate control starts. After that, it continuously monitors the difference between the current time t_{now} and t_{old}. If the difference exceeds Set_Duration (D), it terminates its rate control and stops sending packets.

(7.4) Controlling an interval control, including: recording the timestamp when suspending sending the traffic, monitoring whether the downtime reaches the time interval Set_Interval (I) of two consecutive tests specified by the user, and if so, sending the data packet again.

A large-scale traffic generation system based on programmable network technology includes the following modules:

A task intention primitive module configured to generate task intention primitives. The task intention primitives include two types: traffic generation primitives and traffic control primitives, which are used to clearly express an intention of a large-scale traffic generation task.

A task intention primitive classification module configured to classify the large-scale traffic generation task expressed by the task intention primitives into a hardware compatible primitive set and a hardware incompatible primitive set according to whether the task intention primitives are compatible with a resource limitation of a switch. An initial traffic generation module configured to configure a server group based on

the task intention primitives in the hardware incompatible primitive set to generate a data packet that meet task requirements, and create an initial traffic set.

A server-switch interaction module configured to send the data packet in the initial traffic set and a traffic control configuration in the hardware compatible primitive set to the switch through a link connecting the server group and the switch for controlling a subsequent traffic by a pipeline processing program of the switch when creating an initial traffic.

A traffic control module configured to send and control the initial traffic set sent from the server group by the programmable switch by using a pipeline processor according to traffic control requirements of hardware compatible primitives, allowing the generated large-scale traffic to meet a task configuration requirement.

The present disclosure has the beneficial effects that the description difficulty of the intention of generating large-scale traffic is reduced by abstracting the intention of generating large-scale traffic as task intention primitives; at the same time, the task intention primitives are classified according to the compatibility between the primitive content and the switch, and large-scale traffic is generated and controlled in the switch and server group respectively; at the same time, the design of the cooperation of the server group and switch is used to overcome the resource limitation of the switch, so that the initial traffic can be directly generated and customized in the server based on the task intention primitives, and the flexible traffic control can be carried out in the programmable switch, thus realizing the on-demand generation of large-scale traffic with a low cost and a high scalability.

### BRIEF DESCRIPTION OF DRAWINGS

FIG. 1 is a schematic diagram of the architecture of a large-scale traffic generation method based on programmable network technology of the present disclosure;

FIG. 2 is a schematic diagram of the pipeline operation of the large-scale traffic generation method based on programmable network technology of the present disclosure; and

FIG. 3 is a system flow chart of the present disclosure.

### DESCRIPTION OF EMBODIMENTS

The technical solution in the embodiment of the present disclosure will be clearly and completely described below with reference to the attached drawings. Obviously, the described embodiment is only a part of the embodiment of the present disclosure, but not all of the embodiments. All other embodiments obtained by those skilled in the art based on the embodiments in the present disclosure without creative work belong to the scope of protection of the present disclosure.

According to the present disclosure, the required large-scale traffic is generated on demand by coordinating the server and the programmable network switch, wherein the server group is used for generating data packets of the large-scale traffic and sending the data packets to the programmable switch, and the programmable switch controls the sending speed of the large-scale traffic, thereby realizing the on-demand generation of the large-scale traffic with a low cost and a high scalability. In an embodiment, it includes the steps of designing a series of primitives which are based on intentions and are irrelevant to underlying architecture details, and reducing the description difficulty of generating large-scale traffic intentions; completing required configurations on the switch and the server by the designed cooperation mechanism of the server and programmable switch according to intentions expressed by different types of primitives, and achieving large-scale traffic generation by coordinating and utilizing server and switch resources.

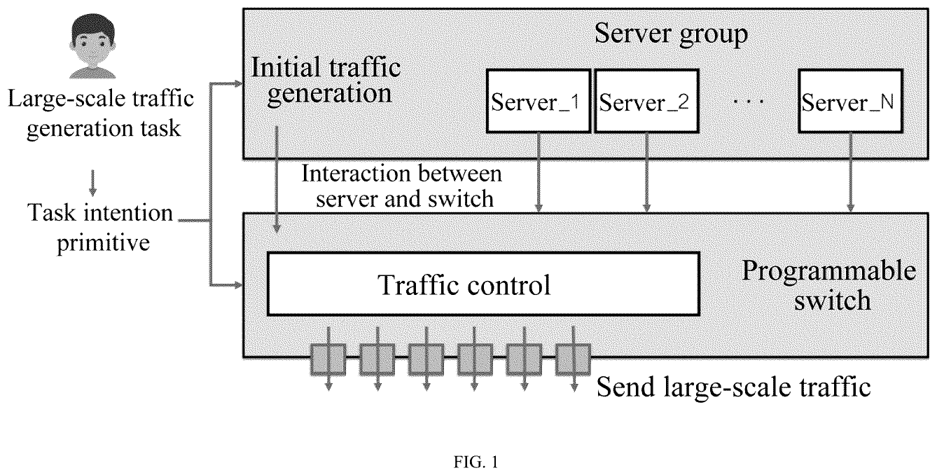

The object of the present disclosure is achieved by the following technical solution: as shown in FIG. 1, the embodiment of the present disclosure provides a large-scale traffic generation method for cooperative configuration of software and hardware of a server and a switch, which includes the following steps:

(1) Task intention primitive generation: the task intention primitives include two types: traffic generation primitives and traffic control primitives, which are used to clearly express an intention of a large-scale traffic generation task T

(2) Task intention primitive classification: according to whether the primitives are compatible with a limitation of switch resources, the traffic generation tasks expressed by the primitives are classified into two sets: a hardware compatible primitive set Ωₚᵢₚₑ and a hardware incompatible primitive set Ωₛₑᵣᵥₑᵣ.

(3) Initial traffic generation: a server group is configured according to the task intention primitives in the hardware incompatible primitive set Ωₛₑᵣᵥₑᵣ to generate data packets that meet task requirements, and then an initial traffic set P_{T} is created.

(4) Server-switch interaction: when the initial traffic is created, the data packets in the initial traffic set P_{T} and a traffic control configuration in the hardware compatible primitive set Ωₚᵢₚₑ are sent to the switch through a link connecting the server group and the switch for controlling a subsequent traffic by a pipeline processing program of the switch.

(5) Traffic control: the programmable switch sends and controls the initial traffic set sent from the server group by using a pipeline processor according to traffic control requirements of hardware compatible primitives, so that the generated large-scale traffic meet task configuration requirements.

The task intention primitive in step (1) is used to describe the intention of a large-scale traffic generation task based on a programmable switch, and an application program interface (API) is provided to support adding new primitives. There are two types of task intention primitives: traffic generation primitives and traffic control primitives.

The traffic generation primitives are used to define the initial data packet format of large-scale traffic, and to generate an initial traffic set with large total traffic but few data packets in a single data flow. The primitives included in this type of primitives are shown in Table 1.

TABLE 1

| Primitive | Meaning of Primitive |
|---|---|
| Set_Packet_{—} | setting the header structure L_{header} of packets |
| Structure(L_{header}) | |
| Select_{—} | selecting a set of header fields L_{field} |
| Field(L_{field}) | |
| Set_Field_{—} | setting the specific header fields L_{field} |
| Value(L_{field}, Lᵥₐₗᵤₑ) | of the data packet as specified values Lᵥₐₗᵤₑ |
| Set_Packet_{—} | setting per-packet length to l |
| Length(l) | |
| Set_Prob(k, | setting k data flows with the largest |
| L_{field}, μₘᵢₙ, μₘₐₓ) | traffic in the initial traffic set, namely |
| | top-k flows, with a probability of occurrence |
| | between μₘᵢₙ and μₘₐₓ |
| Replay_{—} | replaying a given traffic trace F as |
| Trace(F) | the large-scale traffic |

The traffic control primitives are used to express the task intention of controlling the initial traffic set, and these primitives include the attack traffic control primitives shown in Table 2:

TABLE 2

| Primitive | Meaning of Primitive |
|---|---|
| Set_Port(Lₚₒᵣₜ) | setting the switch port list Lₚₒᵣₜ to |
| | emit the large-scale traffic |
| Set_Rate(γ) | setting a rate γ for sending the large-scale traffic |
| Set_Number(Nₜₑₛₜ) | setting a total number of times Nₜₑₛₜ for |
| | sending the large-scale traffic |
| Set_Duration(D) | setting a duration D (seconds) for sending the |
| | large-scale traffic each time |
| Set_Interval(I) | setting a time interval I (seconds) for sending the |
| | large-scale traffic consecutively for two times |

Illustratively, the purpose of the task is to generate a SYN flood attack, which is one of the most common DDOS attacks. The purpose of setting up the test task is to carry out a SYN flood attack of 1 Tbps on the target with an IP address “10.0.0.2” and conduct a stress test lasting for 1 minute. In this context, this embodiment can use five primitives to compose this task T.

P1=Set_Packet_Structure([Ethernet,IPv4,TCP]) that is, P1 specifies the header structure of the test message, which are Ethernet, IPv4 and TCP headers, respectively.

P2=Select_Field([IPv4.srcIP]), that is, P2 sets randomly that the source IP address fields of different test messages.

P3=Set_Field_Value [IPv4.dstIP, TCP.flags], [“10.0.0.2”, “S”]), that is, P3 assigns the value of 10.0.0.2 to the destination address part of the test message, and sets the SYN bit in the TCP flag to 1.

P4=Set_Port([Port1, . . . ,Port10]) that is, P4 selects 10 switch ports (Port1-Port10) to send out attack traffic.

P5=Set_Rate(1000), that is, P5 modifies the sending rate of attack traffic to 1 Tbps.

P6=Set_Duration(60), that is, P6 means that the task lasts for 1 minute. By default, the number of tests is equal to 1.

T=[P1, P2, P3, P4, P5, P6]

The process of the task primitive classification in step (2) specifically includes: each primitive in a task T is enumerated for generating the large-scale traffic. Because the task needs to change the data packet header structures or payloads, and these structures or payloads are disabled on the switch due to the limitation of switch resources. For each primitive P∈T, whether P belongs to an attack traffic generation primitive is determined. If so, P is incompatible with the switch resources, and is added to the hardware incompatible primitive set Ωₛₑᵣᵥₑᵣ; otherwise, P is classified into the hardware compatible primitive set.

Illustratively, the primitive Set_Packet_Structure composes a plurality of headers into a test message, which cannot be realized in a switch. Therefore, P1=Set_Packet_Structure ([Ethernet,IPv4,TCP]) is added to a category Ωₛₑᵣᵥₑᵣ. In the task of generating a SYN flood attack, [P1, P2, P3] is added to Ωₛₑᵣᵥₑᵣ, and [P4, P5, P6] is added to Ωₚᵢₚₑ.

In step (3), the specific steps of creating an attack traffic P_{T} according to the hardware incompatible primitive set Ωₛₑᵣᵥₑᵣ include:

(3.1) Data packet generation: the header structure of the test message is set according to the primitive Set_Packet_Structure(L_{header}). Initializing the fields, establishing the dependency relationship, determining the total number of required test messages, and generating the final attack traffic set P_{T}.

Illustratively, the header structure of the message is tested according to the setting Set_Packet_Structure(L_{header}).

a) L_{header} is converted into a directed sequence P=(V_{P}, E_{P}): V_{P} includes the header in V_{P}. E_{P} includes transitions between the headers.

b) V_{P} is enumerated and the fields of each header in V_{P} is initialized to 0.

c) The dependencies in E_{P} are enumerated. For each dependency item, the two headers associated with the dependency are located. A specific field value is set in one of the headers, and a dependency is created.

d) The total number of required test messages is determined. The proportion of attack traffic in each test package is estimated. Attack traffic instances are created according to the proportion, and are added to the final attack traffic set P_{T}.

(3.2) Setting of field values of the list: the header field of the test message is set according to the primitives Select_Field(L_{field}) and Set_Field_Value(L_{field}, Lᵥₐₗᵤₑ) with a random value or a fixed value, respectively. The primitives Select_Field(L_{field}) and Set_Field_Value(L_{field}, Lᵥₐₗᵤₑ) are used to change the header field of the test message. For each field f∈L_{field} in the list, Select_Field(L_{field}) identifies the corresponding field in the package and sets the value of the field as a random value. Set_Field_Value(L_{field}, Lᵥₐₗᵤₑ) locates the header fields in the data packet according to the L_{field}, and changes the values of these fields to the values in Lᵥₐₗᵤₑ specified by the user.

Illustratively, for P1 =Set_Packet_Structure([Ethernet,IPv4,TCP]), the service generates a TCP message, and for P2=Select_Field([IPv4.srcIP]), the source IP address of the generated TCP message is randomly set. For the primitive P3=Set_Field_Value([IPv4.dstIP, TCP.flags], [“10.0.0.2”, “S”]), the destination IP address of each test message is set to 10.0.0.2.

(3.3) Update of the length of data packets: the payload part of the data packet is intercepted or expanded until the data packet length/specified by Set_Packet_Length(l) is met.

Illustratively, Set_Packet_Length(l) specifies the length of the test data packet. The server agent enumerates each test package P, and if the total length of the test package exceeds an expected length, the test package is intercepted until the length is equal to i; if the length is less than l, the test data packet load is expanded with virtual bytes until the length is equal to the expected length.

(3.4) Setting the data packet probability: the probability that the top k flows appear in the attack traffic is set to be between μₘᵢₙ and μₘₐₓ according to Set_Prob(k, L_{field}, μₘᵢₙ, μₘₐₓ). K data packets with different field values L_{field} are randomly selected from the attack traffic set P_{T} to generate k corresponding streams as the top-k flows, and the characteristics of these flows are caused to meet the requirements for primitive probability (from μₘᵢₙ to μₘₐₓ).

(3.5) Replay of the user-specified data flows: the function of user-defined initial data flows is provided, and a final attack traffic set P_{T} is formed by replaying the user-specified data packets according to Replay_Trace(F). Given a data flow file with a file name F, the application program interface provided by the data Packet Capture Library (libpcap) is used to extract data packets from it to form attack traffic.

The traffic control configuration in Ωₚᵢₚₑ extracted in step (4) includes an expected sending rate γ, the list Lₚₒᵣₜ of switch ports for sending data packets, the total number of times N for sending large-scale traffic, the duration D for sending the traffic each time, and the time interval I between two consecutive traffic transmissions. At the same time, after the initial traffic is generated, the initial traffic set and the traffic control configuration in Ωₚᵢₚₑ are sent to the switch through the link connecting the server and the switch.

The pipeline processor in step (5) receives the initial traffic set P_{T} and the traffic control requirements in the user-specified hardware compatible primitive set Ωₚᵢₚₑ, and uses basic data packet processing elements in a pipeline to control the sending of large-scale traffic. The steps for executing traffic control are as follows:

(5.1) Data message rate control: the large-scale traffic is controlled to be sent out at multiple specified ports Set_Port(Lₚₒᵣₜ) by applying a recycling and color marking mechanism or a multi-pipeline cooperation mechanism, and a traffic rate is controlled for sending out the large-scale traffic to meet a requirement of an expected sending rate Set_Rate(γ). Optionally, the loopback mode of the port can be configured to enhance the recycling ability and improve the performance of controlling the data packet rate.

Illustratively, when γ does not exceed 100 Gbps, the data packets in P_{T} are subjected to recycling and color marking mechanism in a single ASIC pipeline, and the test data packets with a color marking meeting the rate γ is sent; otherwise, recycling is carried out until the rate meets γ. When γ is higher than 100 Gbps, multiple pipeline cooperation mechanisms are used to jointly perform rate control. The rate control operation is classified into several sub-operations, which are assigned to specific pipelines Lₚₒᵣₜ, and the multiple pipelines cooperate to accumulate the sending rate to γ.

(5.2) Data packet termination control: the data packet is counted and the duration is monitored. The sending of the traffic is terminated when a requirement of the number of test times Set_Number(Nₜₑₛₜ) is satisfied.

(5.3) Data packet duration control: a time stamp is recorded when starting to send the data packets and monitoring a difference between a current time and the time stamp, and if the difference reaches the duration Set_Duration(D) of each test specified by the user, stopping sending test data packet.

(5.4) Interval control: a time stamp is recorded when suspending sending the data packets, and whether a downtime reaches the time interval Set_Interval(I) of two consecutive tests specified by the user is monitored, and if so, sending the data packets again.

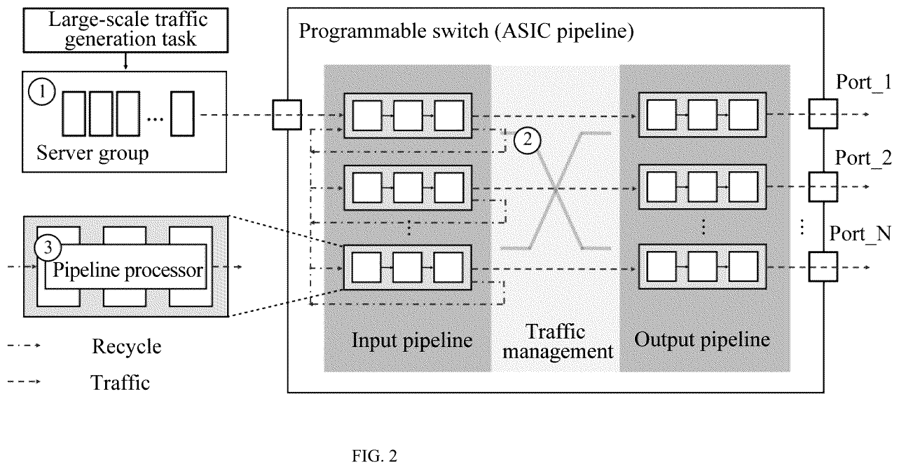

Illustratively, as shown in FIG. 2, a pipeline processing program receives test data packets from a server agent and recycles these data packets. In the recycling process, according to P4=Set_Port([Port1 . . . , Port10]), the test data packets are evenly distributed to Lₚₒᵣₜ=[Port1, . . . , Port10], and each pipeline accelerates the data packets to its maximum transmission rate of 100Gbps, and the aggregation rate reaches 1 Tbps, which meets P5=Set_Rate(1000). At the same time, for P6=Set_Duration(60), in each pipeline, the duration of the ongoing test is monitored by calculating the difference between the current time and the time record when the first data packet is sent out. If the difference exceeds the expected duration D, the test is terminated.

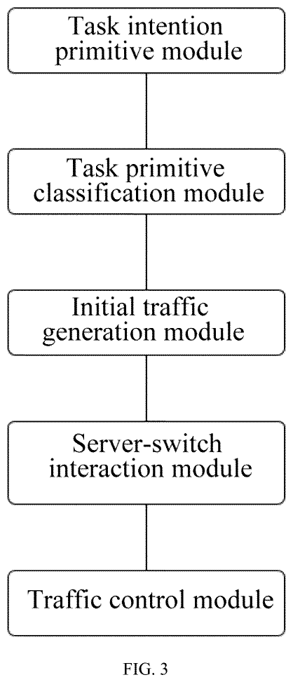

As shown in FIG. 3, it is a system flow chart of the present disclosure, a large-scale traffic generation system based on programmable network technology. The system includes the following modules:

A task intention primitive module configured to generate task intention primitives. The task intention primitives include two types: traffic generation primitives and traffic control primitives, which are used to clearly express an intention of large-scale traffic generation tasks.

A task intention primitive classification module configured to classify the large-scale traffic generation task expressed by the task intention primitives into a hardware compatible primitive set and a hardware incompatible primitive set according to whether the task intention primitives are compatible with a resource limitation of a switch.

An initial traffic generation module configured to configure a server group based on the task intention primitives in the hardware incompatible primitive set to generate data packets that meet task requirements, and create an initial traffic set.

A server-switch interaction module configured to send the data packets in the initial traffic set and a traffic control configuration in the hardware compatible primitive set to the switch through a link connecting the server group and the switch for controlling a subsequent traffic by a pipeline processing program of the switch when creating an initial traffic.

A traffic control module configured to send and control the initial traffic set sent from the server group by the programmable switch by using a pipeline processor according to traffic control requirements of hardware compatible primitives, allowing the generated large-scale traffic to meet a task configuration requirement.

The above embodiments are only used to illustrate, rather than to limit the technical solution of the present disclosure; although the present disclosure has been described in detail with reference to the foregoing embodiments, those skilled in the art should understand that it is still possible to modify the technical solutions described in the foregoing embodiments, or to replace some technical features with equivalents; these modifications or substitutions do not make the essence of the corresponding technical solutions deviate from the spirit and scope of the technical solutions of various embodiments of the present disclosure.

What is claimed is:

1. A large-scale traffic generation method based on programmable network technology, comprising:
step (1) generating task intention primitives, wherein the task intention primitives comprise traffic generation primitives and traffic control primitives for clearly expressing an intent of a large-scale traffic generation task;
step (2) classifying the task intention primitives, comprising: classifying the large-scale traffic generation task expressed by the task intention primitives into a hardware compatible primitive set and a hardware incompatible primitive set according to whether the task intention primitives are compatible with a resource limitation of a switch;
step (3) generating an initial traffic, comprising: configuring a server group based on the task intention primitives in the hardware incompatible primitive set to generate data packets that meet task requirements, and creating an initial traffic set;
step (4) interacting a server with the switch, comprising: when creating the initial traffic, sending the data packets in the initial traffic set and a traffic control configuration in the hardware compatible primitive set to the switch through a link connecting the server group and the switch for controlling a subsequent traffic by a pipeline processing program of the switch; and
step (5) controlling a traffic, comprising: sending and controlling, by a programmable switch, the initial traffic set sent from the server group by using a pipeline processor according to traffic control requirements of hardware compatible primitives, allowing the generated large-scale traffic to meet a task configuration requirement.

2. The large-scale traffic generation method based on programmable network technology according to claim 1, wherein the traffic generation primitives in the step (1) are configured to define an initial format of the data packets of the large-scale traffic, and comprise following primitives:
(2.1) setting the header structure L_{header} of packets: Set_Packet_Structure(L_{header}):
(2.2) selecting a set of header fields L_{field} in different data packets: Select_Field(L_{field});
(2.3) setting the specific header fields L_{field} of the data packets as specified values Lᵥₐₗᵤₑ: Set_Field_Value(L_{field}, Lᵥₐₗᵤₑ);
(2.4) setting per-packet length to l: Set_Packet_Length(l);
(2.5) setting k data flows with the largest traffic in the initial traffic set, namely top-k flows, with a probability of occurrence between μₘᵢₙ and μₘₐₓ: Set_Prob(k, L_{field}, μₘᵢₙ, μₘₐₓ); and
(2.6) replaying a traffic trace F specified by a user as the large-scale traffic: Replay_Trace (F).

3. The large-scale traffic generation method based on programmable network technology according to claim 1, wherein the traffic control primitives in the step (1) are configured to express a task intention of controlling the initial traffic set, and comprise following primitives:
(3.1) setting the switch port list Lₚₒᵣₜ to emit the large-scale traffic: Set_Port(Lₚₒᵣₜ);
(3.2) setting a rate γ for sending the large-scale traffic: Set_Rate(γ);
(3.3) setting a total number of times Nₜₑₛₜ for sending the large-scale traffic:
Set_Number(Nₜₑₛₜ);
(3.4) setting a duration D in seconds for sending the large-scale traffic each time:
Set_Duration (D); and
(3.5) setting a time interval I in seconds for sending the large-scale traffic consecutively for two times: Set_Interval(I)

4. The large-scale traffic generation method based on programmable network technology according to claim 1, wherein said classifying the task intention primitives comprises: enumerating each primitive in a task T for generating the large-scale traffic, wherein the task T needs to change header structures of the data packets or payloads, and these header structures or payloads are disabled on the switch due to switch resource limitations; for each primitive P∈T, it determines whether P belongs to the class of attack traffic generation primitive, wherein when P belongs to the attack traffic generation primitive, P is incompatible with the switch resources, and is added to the hardware incompatible primitive set Ωₛₑᵣᵥₑᵣ; otherwise, P is classified into the hardware compatible primitive set.

5. The large-scale traffic generation method based on programmable network technology according to claim 1, wherein the initial traffic generation in the step (3) comprises:
step (5.1) generating the data packets, comprising: setting a header structure of the data packets based on the primitive Set_Packet_Structure(L_{header}), performing field initialization, establishing a dependency of header fields, and determining a total number of required initial data packets;
step (5.2) setting a set of header fields, comprising: setting the header fields of the data packets in two ways: random values or the fixed values based on primitives Select_Field(L_{field}) and Set_Field_Value(L_{field}, Lᵥₐₗᵤₑ);
step (5.3) updating per-packet length, comprising: intercepting or expanding a payload part of the data packets until meeting the packet length/specified by Set_Packet_Length(l);
step (5.4) setting probabilities of the data packets, comprising: setting the probabilities that top k flows appear in the initial traffic to be between μₘᵢₙ and μₘₐₓ based on Set_Prob(k, L_{field}, μₘᵢₙ, μₘₐₓ); and
step (5.5) replaying user-specified data flows, comprising: providing a function of user-defined initial data flows, and replaying user-specified data packets based on Replay_Trace (F) to form a final attack traffic set P_{T}.

6. The large-scale traffic generation method based on programmable network technology according to claim 1, wherein the traffic control configuration extracted in the step (4) comprises an expected sending rate γ, a switch port list Lₚₒᵣₜ for sending the data packets, the total number of times N for sending the large-scale traffic, a duration D for sending the large-scale traffic each time, and a time interval I for sending the large-scale traffic consecutively for two times.

7. The large-scale traffic generation method based on programmable network technology according to claim 1, wherein the pipeline processor in the step (5) receives the initial traffic set P_{T} and the traffic control requirements in a user-specified hardware compatible primitive set Ωₚᵢₚₑ, and uses basic data packet processing elements in a pipeline to control and send the large-scale traffic, comprising:
step (7.1) controlling a data message rate, comprising: controlling the large-scale traffic to be sent out at multiple specified ports Set_Port(Lₚₒᵣₜ) by applying a recycling and color marking mechanism or a multi-pipeline cooperation mechanism, and controlling a traffic rate to meet the requirement of an expected sending rate Set_Rate(γ);
step (7.2) controlling a data packet termination, comprising: counting the data packets and monitoring the duration, and terminating sending the data packets when exceeding the user-specified test number Set_Number(Nₜₑₛₜ);
step (7.3) controlling the duration of the data packets, comprising: recording a timestamp told indicating when rate control of the data packets starts, after that, continuously monitoring a difference between the current time t_{now} and t_{old}, and terminating the rate control of the data packets and stops sending packets when the difference exceeding Set_Duration(D); and
step (7.4) controlling an interval, comprising: recording the timestamp when suspending sending the traffic, monitoring whether a downtime reaches the time interval Set_Interval(I) of two consecutive tests specified by the user, and when the difference exceeding Set_Interval(I), restarting the execution of rate control.

8. A large-scale traffic generation system based on programmable network technology, comprising:
a task intention primitive module configured to generate task intention primitives, wherein the task intention primitives comprise traffic generation primitives and traffic control primitives for clearly expressing an intent of a large-scale traffic generation task;
a task intention primitive classification module configured to classify the large-scale traffic generation task expressed by the task intention primitives into a hardware compatible primitive set and a hardware incompatible primitive set according to whether the task intention primitives are compatible with a resource limitation of a switch;
an initial traffic generation module configured to configure a server group based on the task intention primitives in the hardware incompatible primitive set to generate a data packet that meet task requirements, and create an initial traffic set;
a server-switch interaction module configured to send the data packets in the initial traffic set and a traffic control configuration in the hardware compatible primitive set to the switch through a link connecting the server group and the switch for controlling a subsequent traffic by a pipeline processing program of the switch when creating an initial traffic; and
a traffic control module configured to send and control the initial traffic set sent from the server group by the programmable switch by using a pipeline processor according to traffic control requirements of hardware compatible primitives, allowing the generated large-scale traffic to meet a task configuration requirement.
